(19) United States
(12) Patent Application Publication
(10) Pub. No.: US 2012/0149422 A1
(43) Pub. Date: Jun. 14, 2012

(54) METHOD OF TRANSMIT POWER CONTROL FOR A RANDOM ACCESS CHANNEL AND THE COMPUTER PROGRAM PRODUCT THEREOF

(75) Inventors: Shiang-Rung Ye, Taipei (TW); Hsiu-Chia Kuo, Changhua (TW); E-Cheng Cheng, Yunlin (TW)

(73) Assignee: INDUSTRIAL TECHNOLOGY RESEARCH INSTITUTE, Hsinchu (TW)

(21) Appl. No.: 12/962,757

(22) Filed: Dec. 8, 2010

(51) Int. Cl. H04W 52/04

(52) U.S. Cl. 455/522

(57) ABSTRACT

A method of transmit power control for a random access channel uses historical information or information from a physical layer to determine the minimum power. In one embodiment, a previous ramping power is taken as a reference power of a current ramping. The reference power is calculated by adding an offset to an initial transmit power level for the current ramping. A mobile access terminal runs the random access procedure at the initial transmit power with the added offset for the current ramping. Once a successful transmission is made during the random access procedure, the successful transmit power level is recorded as a reference power for a next random access procedure, and the transmission continues at the recorded transmit power level. When a retransmission is required, another initial transmit power level is calculated.

### TECHNICAL FIELD

The disclosure generally relates to a method of transmit power control for a random access channel and the computer program product thereof.

### BACKGROUND

Random access channel (RACH) is a shared channel used in wireless access terminals, such as, mobile phones, on a network when the wireless access terminals need to get the attention of a base station for synchronization with the base station for transmission, especially for initial access or bursting data transmission. However, the attempt of getting attention from a base station by a wireless access terminal may sometimes fail due to collision with other simultaneously transmitting wireless access terminals or insufficient transmit power by the wireless access terminal within transmission range. Furthermore, as the cause of failure transmission attempt is often hard to discern, increasing the transmit power blindly is not a viable solution as this approach is likely to waste energy without actual benefit and also contradicts the energy saving criterion of wireless access terminals. For example, the power-ramping algorithm deployed by CDMA systems, wherein the transmit power is ramped up by one step at a time whenever an attempt failure occurs, regardless of the cause of the failure. Hence, to determine an appropriate transmit power is an important issue for wireless mobile networks.

Take the mobile phone network for example. FIG. 1 shows an exemplary schematic view of a conventional power ramping algorithm, where each random access procedure starts afresh from the MIN_POWER, where MIN_POWER is the minimum power that a user equipment (UE), such as mobile phone user, uses to transmit a message to such as a base station (BS). Conventionally, the transmit power P for a random access channel is given by the following equation:

P=MIN_POWER+retx_cnt×step

If the power P is insufficient, the retransmission counter retx_cnt will be incremented by 1 so that the transmit power P for the next retransmission will be incremented by a small amount, step, after each unsuccessful transmission. Once a successful transmission is made, the total ramp-up power is discarded and the next random access procedure needs to start all over again, with initial transmit power set at MIN_POWER. If the path loss compensation path_loss is taken into account, a minor variation of the above equation is as follows:

P=MIN_POWER+retx_cnt×step+path_loss

Various solutions are proposed for the aforementioned problem. For example, U.S. Pat. No. 7,349,715 disclosed a mobile communication terminal for transmitting random access channel signal with various transmission power levels and method thereof, wherein a proper transmission power level of a random access channel is calculated according to a position of the mobile communication terminal in a cell, and the random access channel signal is transmitted at the calculated transmission power level instead of at a maximum power level. So that, UE will monitor the reception power level of the broadcast control channel (BCCH) signal to adjust the preamble power.

U.S. Pat. No. 7,526,307 disclosed a method of stochastic transmission power level adjustment in a random access channel in a radio communication system, wherein the deterministic transmission power level control is replaced by stochastic transmission power level control. The subscriber stations set the transmission power level, and a mean transmission power level is predetermined for a random number generator, The random number generator randomly sets the adjustable transmission power dependent on the predetermined mean transmission power level, wherein the mean transmission power level is based on the measured attenuation values in radio interface between a base station and the subscriber stations.

Furthermore, U.S. Pat. No. 7,177,660 disclosed a radio communication system, wherein a preamble acknowledgement is transmitted by the base station is the preamble transmitted by the mobile station is received and decoded correctly, and the absence of acknowledgement will prompt the mobile station to retransmit at a higher power level. U.S. Publication No. 2007/0115872 disclosed a method for controlling transmission power of a physical random access control, wherein the size of the step is adjustable according to the power level of BCCH. U.S. Publication No. 2008/0259681 disclosed a preamble transmission method for wireless communication system, wherein acknowledgement mechanism is also used in response to preamble successful transmission.

### SUMMARY

The disclosed exemplary embodiments may provide a method of transmit power control for a random access channel and the computer program product thereof, applied to a mobile access terminal running a random access procedure for transmitting messages on the random access channel.

In an exemplary embodiment, the disclosed relates to a method of transmit power control for a random access channel. The method comprises: taking a ramping power of a previous successful random access procedure as a reference power of a current ramping; calculating a reference power by adding an offset to an initial transmit power level for the current ramping; the mobile access terminal running the random access procedure at the initial transmit power with said added offset for the current ramping; once a successful transmission being made during the random access procedure, recording the successful transmit power level as a reference power for a next random access procedure, and continuing the transmission at the recorded transmit power level; and calculating another initial transmit power level for a retransmission when the retransmission is required.

In another exemplary embodiment, the disclosed relates to a computer program product of transmit power control for a random access channel. The computer program product at least includes a memory and an executable computer program stored in the memory. Through a processor or a computer system, the computer program performs: taking a ramping power of a previous successful random access procedure as a reference power of a current ramping; calculating a reference power by adding an offset to an initial transmit power level for the current ramping; the mobile access terminal running the random access procedure at the initial transmit power with said added offset for the current ramping; once a successful transmission being made during the random access procedure, recording the successful transmit power level as a reference power for a next random access procedure, and continuing the transmission at the recorded transmit power level; and calculating another initial transmit power level for a retransmission when the retransmission is required.

The foregoing and other features, aspects and advantages of the present disclosure will become better understood from a careful reading of a detailed description provided herein below with appropriate reference to the accompanying drawings.

### BRIEF DESCRIPTION OF THE DRAWINGS

FIG. 1 shows an exemplary schematic view of a conventional power ramping technique.

FIG. 2 shows an exemplary schematic view, illustrating the initial power is not always the MIN_POWER but may depend on the power level of previous successful transmission, consistent with certain disclosed embodiments.

FIG. 3 shows a flowchart illustrating a method of transmit power control for a random access channel, consistent with certain disclosed embodiments.

FIG. 4 shows an exemplary schematic view, illustrating an offset is added to the initial power of a random access procedure, consistent with certain disclosed embodiments.

FIG. 5 shows an exemplary schematic view, illustrating a transmit power control method is implemented by a computer program product, consistent with certain disclosed embodiments.

### DETAILED DESCRIPTION OF THE EXEMPLARY EMBODIMENTS

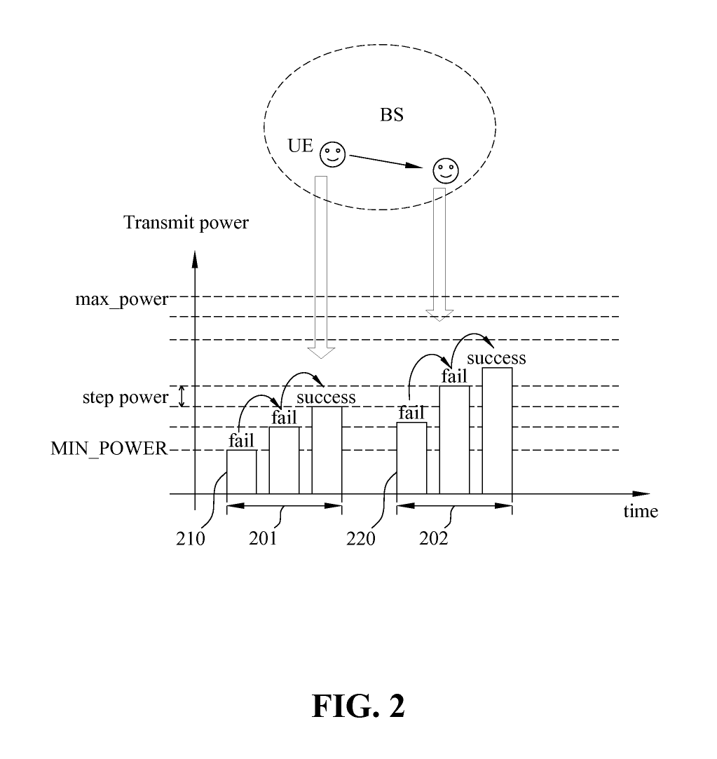

For a mobile station on a cell edge, a correct power may be obtained after several unsuccessful transmission and therefore introduce a longer delay. Moreover, if a mobile station successfully transmit on the random access channel, the correct power may be a reference to setup the initial transmit power for the next random access procedure. In the present disclosure, the exemplary embodiments use historical information or information from a physical layer to determine the MIN_POWER to decrease random access delay and UE power consumption. FIG. 2 shows an exemplary schematic view, illustrating the initial power is not always the MIN_POWER but may depend on the power level of previous successful transmission, consistent with certain disclosed embodiments.

Referring to FIG. 2, the initial power 220 for the second processing time 202 is higher than the initial power 210, i.e. MIN_POWER, for the first processing time 201. Therefore, the present disclosure may utilize the information on transmit power level of previous successful random access procedure so that the initial selection of the transmit power level at the first transmission attempt in the current random access procedure may be more efficient. In comparison with the conventional technique, as shown in FIG. 2, the power ramping computation of the present disclosure starts at a transmit power level higher than the conventional MIN_POWER. With the new initial starting power level, the processing time is also shortened and the random access procedure is more efficient. Thereby, the exemplary embodiments of the present disclosure may use the previous ramping power as the reference power of a current ramping. The reference power may be calculated by adding an offset to the initial transmit power for the k-th random access procedure. The offset may be determined by some parameters, such as escaping time, weights, traffic load and variance of path loss, etc. This will be described in detail later.

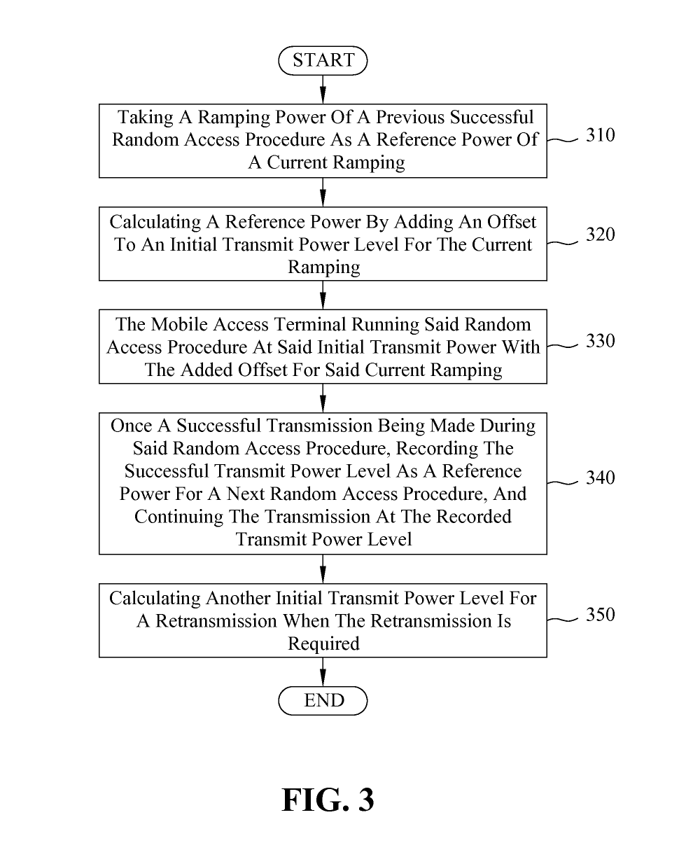

FIG. 3 shows a flowchart illustrating a method of transmit power control for a random access channel, consistent with certain disclosed embodiments. The method may be applied to a mobile access terminal running a random access procedure for transmitting messages on a random access channel in a communication network. Referring to FIG. 3, a ramping power of a previous successful random access procedure is taken as a reference power for a current ramping, as shown in step 310. The reference power is calculated by adding an offset to an initial transmit power level for the current ramping, as shown in step 320. In step 330, the mobile access terminal runs the random access procedure at the initial transmit power for the current ramping. Once a successful transmission is made during the random access procedure, the successful transmit power level is recorded as a reference power for a next random access procedure, and the transmission continues at the recorded transmit power level, as shown in step 340. When a retransmission is required, another initial transmit power level is calculated, as shown in step 350.

It is worth noting that the equation of the present disclosure to calculate the transmit power level Pₖ for the k-th random access procedure is given by:

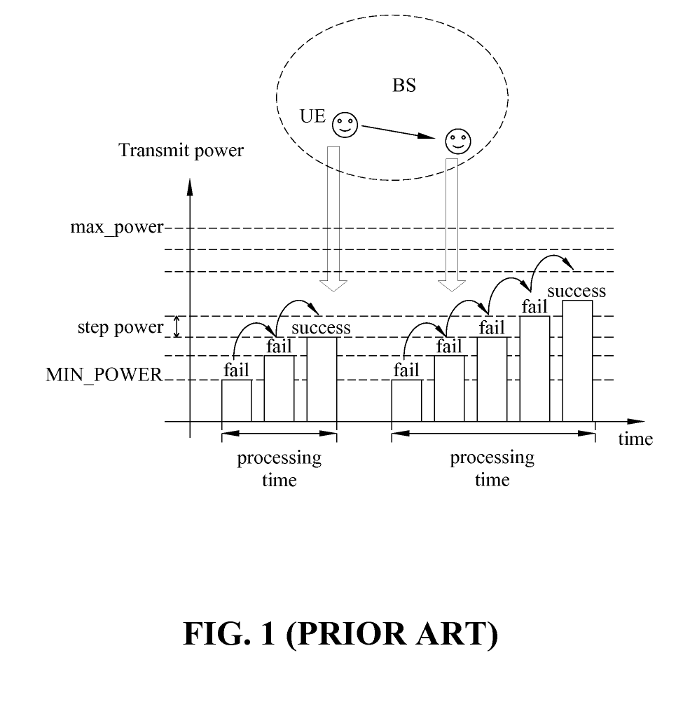

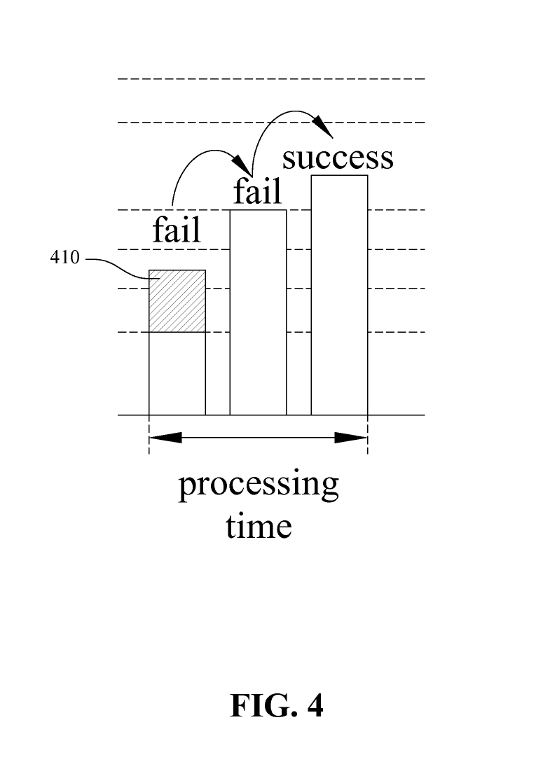

Pₖ=(MIN_POWER+offsetₖ)+retx_cnt×step,k>0,kεN (1)

where offsetₖ is the offset utilizing the information of a previous successful transmission and added initially to reduce random access delay for the k-th random access procedure, retx_cnt is the retransmission count for tracking number of retransmissions in this random access procedure so far, and step is an amount of power incremented after each unsuccessfully transmission. The equation (1) is the equation employed to calculate the transmit power level for transmission attempt in step 304. Compared to the legacy equation such as for FIG. 1, the present disclosure adds an offset 410 to the initial transmit power for the k-th random access procedure, as shown in FIG. 4.

The inclusion of the offset, offsetₖ, of k-th random access procedure is at one of the cores of the present disclosure. Referring to FIG. 3, after the ramping power of a previous successful random access procedure is taken, the transmit power level control method starts with calculating an appropriate offsetₖ for k-th random access procedure. The determination of offset is not limited to any specific equation. In the following, the exemplary embodiments of the present disclosure show how the offset can be determined in an effective manner to exploit the historical information as well as related network information so that the offset may effectively reflect the contribution of the historical information. However any equivalent use of similar information is also within the scope of the present disclosure.

The offset, offsetₖ, of transmit power control for k-th random access procedure may be defined as follows:

offsetₖ=f(Δt,w,l,v,offsetₖ₋₁,rampupₖ₋₁) (2)

In other words, offsetₖ, can be viewed as a function of four independent parameters and two variables indicating historic information from previous random access procedures, namely, elapsing time (Δt), weight (w), traffic load (1), variance of path loss (v), previous offset, i.e., offset of (k−1)-th random access procedure, and previous power ramping-up, i.e., the final power ramping-up of (k−1)-th random access procedure, rampupₖ₋₁. The following describes each parameter separately in details.

First, the offset can be derived from the elapsing time between the successful transmission in (k−1)-th random access procedure and the first transmission time in k-th random access procedure. The rationale is that if the two consecutive random access procedures are sufficiently close, the previous transmit power level information can be effectively used by the subsequent random access procedure. Of course, if the elapsing time between two consecutive random access procedures is too large, i.e., too far apart, the effectiveness of the previous successful random access procedure may become less relevant, or even become completely irrelevant, to the next random access procedure. Hence, a threshold on the elapsing time may be defined to delimit the relevance in terms of elapsing time. The minimum time may be set as the threshold. For example, Long Term Evolution (LTE) standard supports the moving speed of UE up to 500 km/hr and supports the size of base station up to 5 km. The threshold of elapsing time can be set to 36 ms for a moving range of 5 m (i.e., 500 km/hr=5 m/36 ms). If the time difference between two consecutive random access procedures is larger than 36 ms, the relevance between these two procedures may be deemed very low, and the offset can be set to 0. In addition, the offset may be defined as any non-increasing function of the elapsing time. For example, the offset may include a ceiling function, a strictly decreasing function, and so on, and the offset is set to 0 once the elapsing time exceeds the threshold.

The following equations show two examples of the offset in terms of elapsing time and threshold. In the first equation (3.1), the offset value decreases with elapsing time. In the second (3.2), offset value does not change within the threshold boundary but is set to zero once exceeding the threshold boundary.

$$\begin{matrix}{offset}_{k} = max ( 0 , ( 1 - \frac{Δ t}{{t}_{threshold}} ) ) \times ( {offset}_{k - 1} + {rampup}_{k - 1} ) & ( 3.1 ) \\ {offset}_{k} = max ( 0 , ⌈ 1 - \frac{Δ t}{{t}_{threshold}} ) ⌉ ) \times ( {offset}_{k - 1} + {rampup}_{k - 1} ) & ( 3.2 )\end{matrix}$$

Second, the offset can be observed by weights. It can be determined by the priority of the UE or the data to be transmitted, i.e., weights. If the UE is of a higher priority, a larger weight can be assigned to the UE and related random access procedure. Therefore, a larger offset should be given to ensure a faster connecting procedure to the base station. On the other hand, when the UE is of a lower priority, a smaller weight is assigned to the UE and related random access procedure; hence, a smaller offset to reflect that a slower connecting is sufficient of the procedure. For example, if the given weight is w, an exemplary offset may be defined as:

offsetₖ=w×(offsetₖ₋₁+rampupₖ₋₁) (4)

Third, the offset can be observed by traffic load, i.e. the offset can be determined by traffic load of the network. By taking the traffic load of the network into account, the collision factor is also indirectly incorporated into the transmit power level control. When the traffic load is heavy, the offset is set preferably smaller for decreasing the traffic load of the network. On the other hand, a larger offset may be selected to improve the bandwidth efficiency when the traffic load is less heavy. The traffic load information can be obtained in three manners. The first manner is that get the traffic load directly from system information. For example, the used time slots can be counted to estimate the traffic load. The traffic load is heavier when the time slots are occupied more. The second manner is to use the average number of failed random accesses to estimate the traffic load. A high average number of failed random accesses indicate that the traffic load is heavier. The third manner is to get the traffic load from the back off time. The longer back off time means that the traffic load is heavier. Let 1, 0≦l≦1, denote the traffic load, an exemplary offset in terms of traffic load may be defined as:

offsetₖ=(1−l)×(offsetₖ₋₁+rampupₖ₋₁) (5)

Last, the offset can be observed by the variance of the path loss, i.e. the offset can be determined by the variance of the path loss. The path loss can be obtained from physical layer periodically and the variance of path loss can be computed. The variance indicates the communication status between the UE and its base station. Similarly, a threshold may be defined for the variance. One exemplary offset can be set as a near value of the previous offset when the variance is small to reflect the situation that the communication status does not change much. Once the variance exceeds the threshold, the offset can also be set to 0, as shown in the following equation:

$${offset}_{k} = max ( 0 , 1 - \frac{v}{{v}_{threshold}} ) \times ( {offset}_{k - 1} + {rampup}_{k - 1} ) \qquad ( 6 )$$

The above four exemplary offsets, i.e., equations (3.1, 3.2) to equation (6), all include the two variables indicating the historic information of the (k−1)-th successful random access procedure. In this manner, the offset and the final ramping-up power of the most recent successful random access procedure can be exploited to shorten the delay of caused by the conventional technologies.

Furthermore, any combination of the above four parameters used in the embodiments can be determine the offset to reflect the emphasis of the combined factors taken into account when determining the offset used in equation (2).

Once the offset is computed, the computed offset in equation (2) is added to an initial transmit power level for a current ramping to compute the transmit power level for transmission. Once a random access procedure is successful, the offset information and the final ramping-up power level must be recorded for future reference. In this manner, the most recent related information of the network can be maintained.

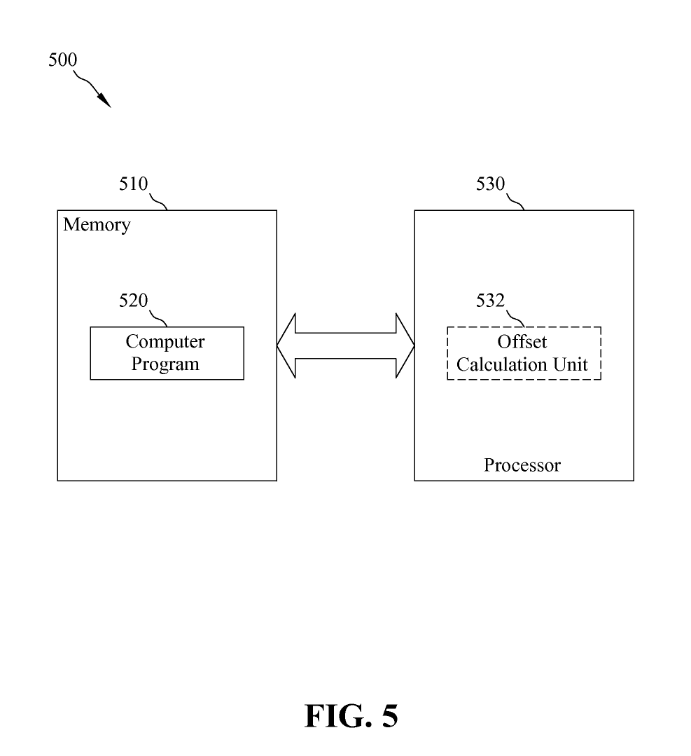

The transmit power control method in FIG. 3 may be implemented by a computer program product. As shown in FIG. 5, a computer program product 500 at least includes a memory 510 and an executable computer program 520 stored in the memory 510. The computer program 520 may perform the steps 310-350 via a processor 530 or a computer system. Processor 530 may further include an offset calculation unit 532 to compute an appropriate offset determined by the four parameters mentioned above. Processor 520 may also compute each parameter, such as, according to equations (3.1, 3.2) to equation (6), respectively.

Although the disclosed has been described with reference to the exemplary embodiments, it will be understood that the disclosure is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for transmit power control for a random access channel, applied to a mobile access terminal running a random access procedure for transmitting messages on said random access channel to a base station in a wireless network, said method comprising:
taking a ramping power of a previous successful random access procedure as a reference power of a current ramping;
calculating a reference power by adding an offset to an initial transmit power level for the current ramping;
said mobile access terminal running said random access procedure at said initial transmit power with said added offset for said current ramping;
once a successful transmission being made during said random access procedure, recording the successful transmit power level as a reference power for a next random access procedure, and continuing the transmission at the recorded transmit power level; and
calculating another initial transmit power level for a retransmission when the retransmission is required.

2. The method as claimed in claim 1, wherein said offset is determined by any one combination of an elapsing time, a weight, a traffic load, a variance of path loss, an offset of a previous successful random access procedure, and a final power ramping-up level of said previous successful random access procedure.

3. The method as claimed in claim 2, wherein said elapsing time is the time between a current time and time of said previous successful random access procedure, said offset is a function of an elapsing time, a defined time threshold, offset of said previous successful random access procedure and final power ramping-up of said previous successful random procedure, and said offset is expressed as:
$${offset}_{k} = max ( 0 , ( 1 - \frac{Δ t}{{t}_{threshold}} ) ) \times ( {offset}_{k - 1} + {rampup}_{k - 1} )$$
where said offsetₖ is the offset to be computed, Δt is said elapsing time, t_{threshold} is said defined time threshold, offsetₖ₋₁ is the offset of said previous successful random access procedure, and rampupₖ₋₁ is said final power ramping-up of said previous successful random procedure.

4. The method as claimed in claim 2, wherein said elapsing time is the time between current time and time of said previous successful random access procedure, said offset is a function of an elapsing time, a defined time threshold, an offset of said previous successful random access procedure and a final power ramping-up of said previous successful random procedure, and said offset is expressed as:
$${offset}_{k} = max ( 0 , ⌈ 1 - \frac{Δ t}{{t}_{threshold}} ) ⌉ ) \times ( {offset}_{k - 1} + {rampup}_{k - 1} )$$
where said offsetₖ is the offset to be computed, Δt is elapsing time, t_{threshold} is said defined time threshold, offsetₖ₋₁ is said offset of said previous successful random access procedure, and rampupₖ₋₁ is said final power ramping-up of said previous successful random procedure.

5. The method as claimed in claim 2, wherein said weight is determined by a priority of said mobile access terminal or data to be transmitted, said offset is a function of an assigned weight, an offset of said previous successful random access procedure and final power ramping-up of said previous successful random procedure, and said offset is expressed as:
offsetₖ=w×(offsetₖ₋₁+rampupₖ₋₁)
where said offsetₖ is the offset to be computed, w is said assigned weight, offsetₖ₋₁ is said offset of said previous successful random access procedure, and rampupₖ₋₁ is said final power ramping-up of said previous successful random procedure.

6. The method as claimed in claim 2, wherein said traffic load is a traffic load of said wireless network, and when said traffic load is heavy, said offset is set smaller for decreasing the traffic load of said wireless network, and when said traffic load is light, said offset is set to be larger to improve bandwidth efficiency of said wireless network, and said offset is a function of said traffic load, offset of said previous successful random access procedure and final power ramping-up of said previous successful random procedure, and said offset is expressed as:
offsetₖ=(1−l)×(offsetₖ₋₁+rampupₖ₋₁)
where said offsetₖ is the offset to be computed, 1 is said traffic load, 0≦l≦1, offsetₖ₋₁ is said offset of said previous successful random access procedure, and rampupₖ₋₁ is said final power ramping-up of said previous successful random procedure.

7. The method as claimed in claim 6, wherein said traffic load information is obtained directly from system information, or using an average number of failed random accesses to estimate the traffic load, or from a back off time.

8. The method as claimed in claim 2, wherein said variance of path loss indicates communication status between said mobile access terminal and said base station, said offset is a function of said variance of path loss, variance threshold, offset of said previous successful random access procedure and final power ramping-up of said previous successful random procedure, and said offset is expressed as:
$${offset}_{k} = max ( 0 , 1 - \frac{v}{{v}_{threshold}} ) \times ( {offset}_{k - 1} + {rampup}_{k - 1} )$$
where said offsetₖ is the offset to be computed, v is said variance of path loss, v_{threshold} is said variance threshold, offsetₖ₋₁ is said offset of said previous successful random access procedure, and rampupₖ₋₁ is said final power ramping-up of said previous successful random procedure.

9. The method as claimed in claim 1, wherein said reference power P is calculated by:
P=(MIN_POWER+offset)+retx_cnt×step
where MIN_POWER is a minimum power level that said mobile access terminal uses to transmit a message to said base station, retx_cnt is a counter indicating number of times of retransmissions, sand step is an incremental power level to ramp up.

10. A computer program product for transmit power control for a random access channel, applied to a mobile access terminal running a random access procedure for transmitting messages on said random access channel to a base station in a wireless network, said computer program product at least includes a memory and an executable computer program stored in said memory, through a processor or a computer system, said computer program performs:
taking a ramping power of a previous successful random access procedure as a reference power of a current ramping;
calculating a reference power by adding an offset to an initial transmit power level for the current ramping;
said mobile access terminal running the random access procedure at said initial transmit power with said added offset for the current ramping;
once a successful transmission being made during said random access procedure, recording said successful transmit power level as a reference power for a next random access procedure, and continuing the transmission at the recorded transmit power level; and
calculating another initial transmit power level for a retransmission when the retransmission is required.

11. The computer program product as claimed in claim 10, wherein said offset is determined by any one combination of an elapsing time, a weight, a traffic load, a variance of path loss, an offset of a previous successful random access procedure, and a final power ramping-up level of said previous successful random access procedure.

12. The computer program product as claimed in claim 10, wherein said processor further includes an offset calculation unit to compute said offset.

13. The computer program product as claimed in claim 10, wherein said reference power P is calculated by:
P=(MIN_POWER+offset)+retx_cnt×step
where MIN_POWER is a minimum power level that said mobile access terminal uses to transmit a message to said base station, retx_cnt is a counter indicating number of times of retransmissions, sand step is an incremental power level to ramp up.
